(19) United States
(12) Patent Application Publication
(10) Pub. No.: US 2008/0094557 A1
(43) Pub. Date: Apr. 24, 2008

(54) Liquid Crystal Based Light Control Element

(75) Inventors: Stein Kuiper, Vught (NL); Emile J.K. Verstegen, Eindhoven (NL); Bernardus H.W. Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,885

(22) PCT Filed: Dec. 29, 2005
(86) PCT No.: PCT/IB05/54424

§ 371 Date: Jun. 27, 2007

(30) Foreign Application Priority Data
Jan. 6, 2005 (GB) 0500116.9

(51) Int. Cl. G02F 1/13; G02F 1/1337; G02F 1/1343

(52) U.S. Cl. 349/123; 349/193; 349/139

(57) ABSTRACT

A light control element (100) is disclosed having a first chamber (110) encapsulating a first liquid crystal based light absorbing material (112; 114) being switchable from a first orientation in which said material (112; 114) predominantly absorbs light having a first polarization direction to a second orientation in which said material (112; 114) is substantially transparent and that further has a second chamber (120) encapsulating a second liquid crystal based light absorbing material (122; 124) being switchable from a first further orientation in which said material (122; 124) predominantly absorbs light having a polarization direction substantially perpendicular to the first polarization direction to a second further orientation in which said material (122; 124) is substantially transparent. A plurality of electrodes is present for switching the orientations of the first and second light absorbing materials. Consequently, a polarization independent light control element (100) is obtained.

The present invention relates to a light control element comprising a chamber containing a liquid crystal material.

The present invention further relates to an electronic device comprising such a light control element.

Several examples of light control elements such as diaphragms and optical shutters are known. Such elements are attractive because they have relatively high switching speeds and lack mechanically moving parts, which makes them less prone to wear and tear.

For example, European patent EP 1186941 discloses a shutter based on a guest-host system including a liquid crystal and a dichromatic dye. Light having an appropriate polarization direction is selected by a polarizer in front of the shutter, which can be switched from a transparent mode in which the principal axis of absorption of the dye has no overlap with the polarization direction of the light to an absorbing mode in which the absorption axis of the dye overlaps with the polarization direction of the light. This solution has the drawback that at least 50% of the light intensity is lost even in the transparent mode of the shutter because of the use of the polarizer.

An LC based shutter that does not require polarizers is disclosed in Japanese patent application JP57066418. The shutter consists of two LC plates, each containing a liquid crystal material that can be switched between a light-scattering mode and a transparent mode. The first LC plate is arranged to selectively block the transmission of light having a longitudinal polarization direction by the orientation of a pair of transparent electrodes over the main surface of the LC plate, and the second LC plate is arranged to selectively block the transmission of light having a lateral polarization direction by means of an electrode pair on the side of this LC plate. Unfortunately, the different orientations of the electrodes over the two chambers complicate the manufacturing of this shutter, making it more costly.

In Japanese patent application JP04349423, another LC based shutter is disclosed that does not require polarizers. The shutter consists of at least two chambers encapsulating a nematic LC material. Nematic LC materials are attractive because they can be switched between a scattering state and a transparent state without the need for alignment materials. However, nematic LC materials do not obtain a 100% light scattering efficiency, and the light blocking efficiency of the shutter has to be improved by cascading a plurality nematic LC cells to obtain a reasonably efficient shutter. However, if the plurality of cells is relatively small, e.g. two as in JP04349423, such a shutter still does not completely block the transmission of light.

The present invention seeks to provide an improved liquid crystal based light control element.

The present invention further seeks to provide an electronic device having such an improved liquid crystal based light control element.

According to a first aspect of the present invention, there is provided a light control element comprising a first chamber encapsulating a first liquid crystal based light absorbing material being switchable from a first orientation in which said material predominantly absorbs light having a first polarization direction to a second orientation in which the material is substantially transparent; a second chamber encapsulating a second liquid crystal based light absorbing material being switchable from a first orientation in which said material predominantly absorbs light having a polarization direction substantially perpendicular to the first polarization direction to a second orientation in which the material is substantially transparent; and a plurality of electrodes for switching the orientations of the first and second light absorbing materials, said electrodes preferably being oriented in parallel with respect to each other.

The invention is based on the realization that the ability to switch a liquid crystal based light absorbing material such as a guest-host system of a liquid crystal material and a light absorbing dye, which preferably is a dichromatic dye, between different organized states can be utilized to form a polarization independent light control device such as a shutter or a diaphragm, in contrast to the prior art polarization independent light control elements such as those disclosed in JP57066418 and JP04349423, which utilize the principle of light scattering from an unorganised, chaotic state of the LC material for the light blocking mode.

This realization leading to the invention originates from the recognition that the light absorbing materials not only absorb light having a polarization direction in parallel with the principle axis of absorption of the chromophore in the light absorbing material, but also absorb, albeit less effectively, light having a polarization direction under an angle with this absorption axis, with the absorption effectiveness being inversely proportional to the magnitude of the angle and approaching zero for angles close to 90°. Thus, by including two light absorbing LC based materials having their maximum absorption effectiveness for perpendicular light polarization directions, a very effective light absorbing light control element is obtained that does not require polarizers.

This element has the advantage over JP57066418 that all the electrodes may be oriented in parallel with each other, which makes the light control element easier to manufacture, and it has the advantage over JP04349423 that a better light blocking efficiency is obtained. Moreover, because the incident light is absorbed rather than scattered in the dark state of the light control element, in contrast with the devices disclosed in the aforementioned Japanese patent applications, no light is reflected from the light control element, which may be of importance in situations where light reflection should be avoided, e.g. arrangements with multiple light detection elements such as sensor arrays.

Preferably, the first light absorbing material is sandwiched between a first pair of alignment layers for forcing the first light absorbing material in one of the first orientation and second orientation and the second light absorbing material is sandwiched between a second pair of alignment layers for forcing the second light absorbing material in one of the first further orientation and second further orientation. This has the advantage that, in the absence of an electric field, a very precise perpendicular alignment of the two light absorbing materials can be achieved. Alternatively, the desired alignment effect can be achieved by rubbing the inner surfaces of the two chambers in perpendicular directions.

In an embodiment, the first chamber comprises a first stepped surface covered by an alignment layer of the first pair of alignment layers and the second chamber comprises a second stepped surface covered by an alignment layer of the second pair of alignment layers. Consequently, the depth of the light path through the light absorbing material varies over the width of the light control element, which causes a difference in absorption intensity when the light absorbing material is in the first position. Thus, the light control element functions as a diaphragm in this embodiment.

In a further embodiment, the first stepped surface and the second stepped surface are the main surfaces of a partition wall between the first chamber and the second chamber. This has the advantage that the light control element can be made from a single container in which a partition wall is placed to form the two chambers, which makes the light control element easier to manufacture.

In an alternative embodiment, the first chamber and the second chamber are separated by a foil being permeable by an electric field. This also has the advantage that the light control element can be made from a single container, which makes the light control element easier to manufacture.

Advantageously, the plurality of electrodes comprises an electrode pair having a first electrode in the first chamber and a second electrode in the second chamber. In several embodiments of the light control element of the present invention, the absorption of the two principal polarization directions of the light can be controlled by using a single pair of electrodes, which yield a simpler and more compact light control element than previously disclosed. This is especially advantageous in the field of mobile communication devices that include light control elements, where minimizing the form factor of the integrated light control elements facilitates the desirable size reduction of the communication device.

In a further embodiment, the plurality of electrodes comprises a first plurality of ring electrodes and a second plurality of ring electrodes opposite the first plurality of ring electrodes. This way, an electric field gradient can be applied perpendicular to the light path through the light control element, which enables the light control element to be operated as a diaphragm.

According to a further aspect of the invention, there is provided an electronic device comprising a light sensor coupled to a processor, and an aforementioned embodiment of a light control element of the present invention placed in front of the light sensor, the electronic device further comprising driver circuitry coupled to the electrode pair.

The invention is described in more detail and by way of non-limiting examples with reference to the accompanying drawings, wherein:

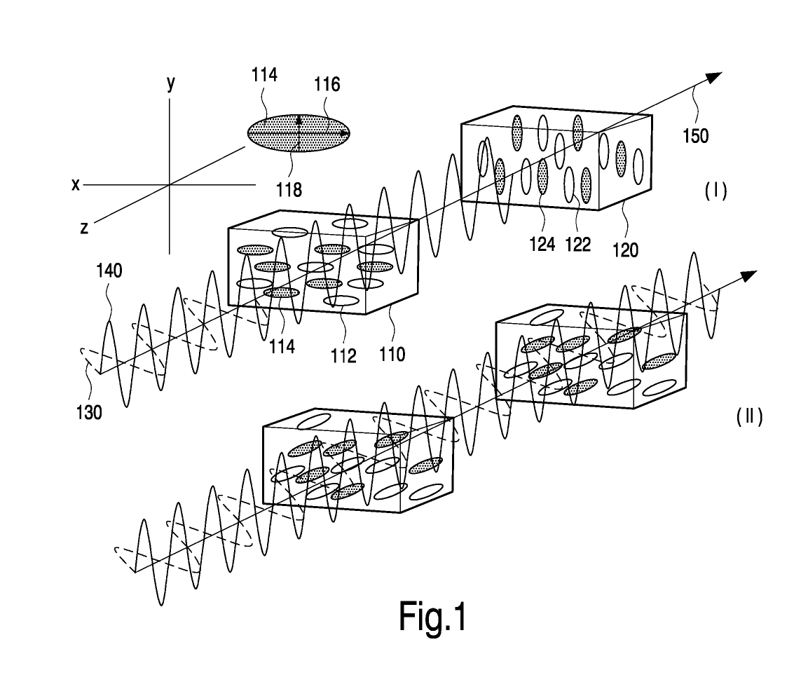

FIG. 1 shows a scheme in which the operational concept of the light control element of the present invention is explained;

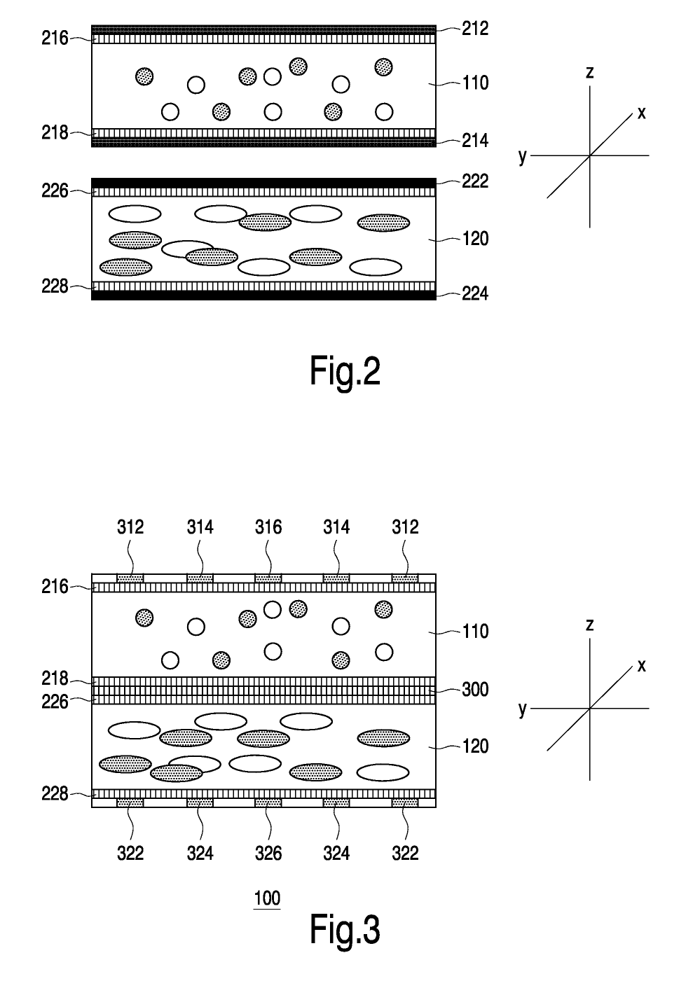

FIG. 2 shows an embodiment of a light control element of the present invention;

FIG. 3 shows another embodiment of a light control element of the present invention;

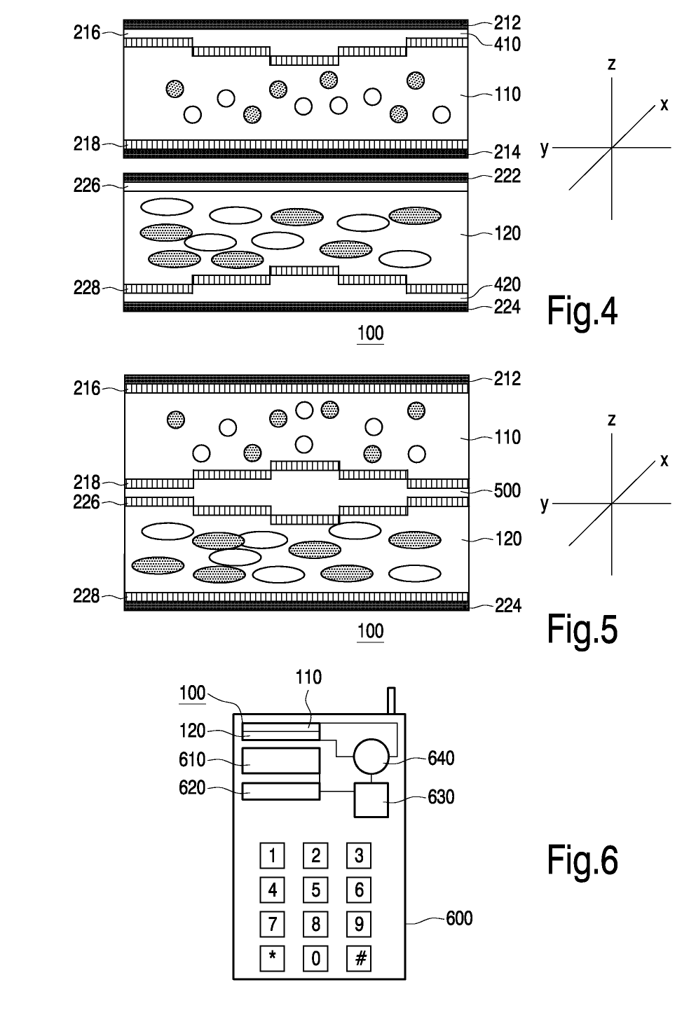

FIG. 4 shows yet another embodiment of a light control element of the present invention;

FIG. 5 shows yet another embodiment of a light control element of the present invention; and

FIG. 6 shows an electronic device including a light control element of the present invention.

It should be understood that the Figures are merely schematic and are not drawn to scale. It should also be understood that the same reference numerals are used throughout the Figures to indicate the same or similar parts.

As can be seen in FIG. 1, the light control element 100 according to the present invention comprises a first chamber 110 and a second chamber 120. The first chamber encapsulates a first liquid crystal material 112 and a first chromophore 114, which may be a part of the liquid crystal 112, or which may be covalently or ionically bound to the first liquid crystal material 112 or which may form a guest-host system with the first liquid crystal material 112. Similarly, the second chamber 120 encapsulates a second liquid crystal material 122 and a second chromophore 124, which may be covalently or ionically bound to the second liquid crystal material 122 or which may form a guest-host system with the second liquid crystal material 122.

The first chromophore 114 and the second chromophore 124 may be dyes and preferably are dichromatic dyes. The first liquid crystal material 112 may be the same material as the second liquid crystal material 122, and the first chromophore 114 may be the same chromophore as the second chromophore 124, although this is not necessary. The liquid crystal based light absorbing materials may be a known liquid crystal based light absorbing material such as the of the liquid crystal material based guest host systems disclosed in European patent applications EP1186941 and EP1197786, and other examples will be readily available to the skilled person. For instance, a dual-frequency liquid crystal material such as disclosed in U.S. Pat. No. 6,469,683 is also suitable for use in the present invention.

In a first orientation (I), the molecules of the first liquid crystal 112 and the first chromophore 114 in the first chamber 110 are oriented in the x-direction of the coordinate system shown in the top left corner of FIG. 1, whereas the molecules of the second liquid crystal 122 and the second chromophore 124 in the second chamber 120 are oriented in the y-direction of the coordinate system. The principal polarization directions of the incident light are oriented in the x-direction and the y-direction, as indicated by dashed curve 130 and solid curve 140. The light travels in the z-direction, as indicated by arrow 150.

The first chromophore 114 and the second chromophore 124 preferably have an anisotropy with respect to the absorption of the incident light. In case of a positive anisotropy, the chromophores more effectively absorb light having a polarization direction parallel to their major axis 116, whereas in case of a negative anisotropy, the more effective absorption takes place for light having a polarization direction parallel to their minor axis 118. In FIG. 1, the operation of the light control element is explained using chromophores having a positive anisotropy, but this is by way of example only; chromophores having a negative anisotropy are equally acceptable.

In the first orientation (I), the first chromophore 114 in the first chamber 110 effectively absorbs the light having a polarization component in the x-direction, whereas the second chromophore 124 in the second chamber 120 effectively absorbs the light having a polarization component in the y-direction, thus preventing the incident light from travelling through the light control element 100. In the second orientation (II), the major axis of the first chromophore 114 and the major axis of the second chromophore 124 are oriented in the z-direction. In this orientation direction, the chromophores do not significantly absorb any of the incident light, which consequently is allowed to travel through the light control element 100.

In a preferred solution, the first orientation (I) of the respective liquid crystal based light absorbing materials in the first chamber 110 and the second chamber 120 is achieved by sandwiching each of the liquid crystal based light absorbing materials between a pair of alignment layers, or by rubbing the inner walls of the chambers. The second orientation (II) is achieved by subjecting the light absorbing materials in the first chamber 110 and the second chamber 120 to an electric field in the z-direction. Such a field can be generated by pairs of electrodes (not shown) oriented in parallel with each other.

However, alternative ways of invoking the required first and second orientation are available; for instance, the first orientation (I) of the first liquid crystal based light absorbing material in the first chamber 110 can be achieved by application of an electric field in the x-direction and the first orientation (I) of the second liquid crystal based light absorbing material in the second chamber 120 can be achieved by application of an electric field in the y-direction, with the second orientation (II) of these materials being generated by means of alignment layers or rubbing.

In the following Figures, the light is assumed to travel in the z-direction of the coordinate frames shown therein.

In a first embodiment of the light control device 100 according to the present invention, as shown in FIG. 2, the first chamber 110 and the second chamber 120 are discrete, separate chambers, with the first chamber 110 carrying a first transparent electrode 212 covered by an alignment layer 216 in the plane of the light entry surface of the first chamber 110 and a second transparent electrode 214 covered by an alignment layer 218 in the plane of the light exit surface of the first chamber 110. The first LC based light absorbing material in the first chamber 110 is oriented in the x-direction. Similarly, the second chamber 120 carries a first transparent electrode 222 covered by an alignment layer 226 in the plane of the light entry surface of the second chamber 120 and a second transparent electrode 224 covered by an alignment layer 228 in the plane of the light exit surface of the second chamber 120. The second LC based light absorbing material in the second chamber 110 is oriented in the y-direction. The first chamber 110 and the second chamber 120 are shown separated from each other for reasons of clarity only; it is equally feasible that the light exit surface of the first chamber 110 is in contact with the light entry surface of the second chamber 120.

The electrodes shown in FIG. 2 and the following Figures may be made of any known transparent conductive material, e.g. indium tin oxide (ITO). The alignment layers shown in FIG. 2 and the following Figures may be formed from any known suitable alignment material.

In FIG. 3, another embodiment of a light control element 100 according to the present invention is shown. The first chamber 110 and the second chamber 120 are separated by a transparent foil 300 carrying alignment layers 218 and 226 on its surfaces. The transparent foil 300 may be any foil that is inert to the alignment materials used on its surfaces. The foil 300 is thin enough to allow an electric field to travel through the foil 300 without substantial field strength loss. This facilitates the use of a single pair of electrodes or electrode structures in the light control element 100; one electrode or electrode structure on a single surface of the first chamber 110 and another electrode or electrode structure on a single surface of the second chamber 120.

By way of example, the first chamber 110 further comprises a first electrode structure comprising a set of concentric ring electrodes 312, 314 and 316 and the second chamber 120 further comprises a second electrode structure comprising a set of concentric ring electrodes 322, 324 and 326 placed opposite the set of concentric ring electrodes 312, 314 and 316. Thus, three electrode pairs are formed; a first pair formed by electrodes 312 and 322, a second pair formed by electrodes 314 and 324 and a third pair formed by electrodes 316 and 326. The electrode pairs may be independently controllable to allow for the creation of a gradient in the electric field in the xy plane, e.g. an electric field that increases in strength from the first pair of electrodes 312 and 322 towards the third pair of electrodes 316 and 326. Such a gradient can also be achieved by conductively interconnecting the concentric ring electrodes on a surface, e.g. electrodes 312, 314 and 316, through a resistive coupling, in which case the electrode pairs can be controlled by the application of a single voltage.

The application of such a radial electric field causes the light absorbing molecules to become more effectively aligned in the z-direction in the centre of the light control element 100, and less effectively aligned the outer regions of the light control element 100. This will cause a residual absorption of light in the outer regions. Consequently, the light control element 100 operates as a diaphragm. By variation of the voltage applied to the electrode pairs the diaphragm strength can be tuned.

At this point, it is emphasized that the use of concentric ring electrodes to implement diaphragm functionality is equally feasible for the light control element 100 shown in FIG. 2. Also, the concentric ring electrodes 312, 314 and 316 on the surface of the first chamber 110 and the concentric ring electrodes 322, 324 and 326 on the surface of the second chamber 120 may be replaced by two single electrodes on said surfaces to obtain a shutter rather than a diaphragm. Also, the ring electrodes may have other shapes than a concentric shape.

FIG. 4 shows another embodiment of the light control element 100 of the present invention acting as a diaphragm without the need for the concentric ring electrodes shown in FIG. 3. The first chamber 110 comprises a first transparent stepped surface 410 covered by an alignment layer 216 and the second chamber 120 comprises a second transparent stepped structure covered by an alignment layer 228. The steps in the stepped structures 410 and 420 create a radial variation in the thickness of the layers of the light absorbing materials in the first chamber 110 and the second chamber 120. Consequently, the absorption of light is least effective in the centre of the light path the light control element 100, where the thickness of the layers of the light absorbing materials is the smallest.

Furthermore, by choosing the dielectric constant of the first stepped structure 410 to be different to the dielectric constant of the first light absorbing material in the first chamber 110 and the dielectric constant of the second stepped structure 420 to be different to the dielectric constant of the second light absorbing material in the second chamber 120, a radial gradient in the response of the light absorbing materials to an applied electric field in the z-direction is obtained. For instance, if the stepped structures have a smaller dielectric constant than the light absorbing materials, the effective dielectric constant of the light control element 100 increases from its centre towards its outer regions. Thus, the light absorbing material switches more easily in the central areas of the light control device 100 than in its outer regions. Thus, by varying the voltage that is applied to the electrodes of the light control device 100, the area of light absorbing material in the xy plane that is effectively switched can be varied, and a switchable diaphragm is obtained.

In FIG. 5, a switchable diaphragm having a partition wall 500 carrying a first stepped surface in the first chamber 110 and a second stepped surface in the second chamber 120 is disclosed. The operation principle is the same as for the switchable diaphragm shown in FIG. 4, but because the first chamber 110 and the second chamber 120 are separated by the partition wall 500 only, a single pair of electrodes 514 and 518 may be used to control the switchable diaphragm if the partition wall 500 is sufficiently thin.

At this point it is emphasized that care has to be taken that the steps on the stepped structures 410 and 420 in FIG. 4 and the stepped structure 500 are sufficiently flat to avoid that the stepped structures exhibit non-unity optical power and act as a Fresnel type lens, unless lens-type behaviour of these structures is desirable. Stepped structures with sufficiently flat steps can be obtained using well-known photo-replication techniques.

At this point it is also emphasized that as an alternative, the steps of the stepped structures 410 and 420 in FIG. 4 and the stepped structure 500 in FIG. 5 may be covered by an electrode layer (not shown). Such a layer can be easily formed by deposition, e.g. sputtering, of a conductive material such as ITO on the steps of said stepped structures. This has the advantage that the gradient in light absorption across the diaphragm caused by the variation in thickness of the LC layers is amplified by a variation in the strength of the electric field between the electrodes, due to the fact that the distance between the two electrodes in an electrode pair varies as well.

FIG. 6 shows a mobile telecommunication device as an example of an electronic device 600 according to the present invention. The electronic device 600 has a light control element 100 of the present invention placed in front of an image sensor 620. A lens 610, which may be a fixed lens, a zoom lens or a variable focus lens, may be placed in between the light control element 100 and the light sensor 620. A processor 630 is coupled between the light sensor 620 and driver circuitry 640. The processor 630 is arranged to process the output signal of the light sensor 620 and to provide the driver circuitry 640 with a control signal. The driver circuitry 640 is arranged to provide the electrodes in the first chamber 110 and the second chamber 120 of the light control element 100 with a driving voltage in response to the control signal. Further driver circuitry (not shown) coupled between the processor 630 and the lens 120 and responsive to a further control signal generated by the processor 630 may also be present in case the lens 610 has variable optical power.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A light control element (100) comprising:
a first chamber (110) encapsulating a first liquid crystal based light absorbing material (112; 114) being switchable from a first orientation in which said material (112; 114) predominantly absorbs light having a first polarization direction to a second orientation in which said material (112; 114) is substantially transparent; and
a second chamber (120) encapsulating a second liquid crystal based light absorbing material (122; 124) being switchable from a first further orientation in which said material (122; 124) predominantly absorbs light having a polarization direction substantially perpendicular to the first polarization direction to a second further orientation in which said material (122; 124) is substantially transparent; and
a plurality of electrodes (212, 214, 216, 218, 312, 314, 316, 322, 324, 326) for switching the orientations of the first and second light absorbing materials.

2. A light control element (100) as claimed in claim 1, wherein said electrodes are oriented in parallel with respect to each other.

3. A light control element (100) as claimed in claim 1, wherein the first liquid crystal based light absorbing material (112; 114) comprises a liquid crystal material (112) and a dye (114), and the second liquid crystal based light absorbing material (122; 124) comprises a further liquid crystal material (122) and a further dye (124).

4. A light control element (100) as claimed in claim 3, wherein the dye (114) and the further dye (124) are dichromatic dyes.

5. A light control element (100) as claimed in claim 1, wherein the first light absorbing material (112; 114) is sandwiched between a first pair of alignment layers (216; 218) for forcing the first light absorbing material (112; 114) in one of the first orientation and second orientation and the second light absorbing material (122; 124) is sandwiched between a second pair of alignment layers (226; 228) for forcing the second light absorbing material (122; 124) in one of the first further orientation and second further orientation.

6. A light control element (100) as claimed in claim 5, wherein the first chamber (110) comprises a first stepped surface (410) covered by an alignment layer (216) of the first pair of alignment layers (216; 218) and the second chamber (120) comprises a second stepped surface (420) covered by an alignment layer (228) of the second pair of alignment layers (226; 228).

7. A light control element (100) as claimed in claim 6, wherein the first stepped surface and the second stepped surface are the main surfaces of a partition wall (500) between the first chamber (110) and the second chamber (120).

8. A light control element (100) as claimed in claim 1, wherein the first chamber (110) and the second chamber (120) are separated by a foil (300) being permeable by an electric field.

9. A light control element (100) as claimed in claim 1, wherein the plurality of electrodes comprises an electrode pair having a first electrode (212) in the first chamber (110) and a second electrode (224) in the second chamber (120).

10. A light control element (100) as claimed in claim 1, wherein the plurality of electrodes comprises a first plurality of ring electrodes (312, 314, 316) and a second plurality of ring electrodes (322, 324, 326) opposite the first plurality of ring electrodes (312, 314, 316).

11. An electronic device (600) comprising a light sensor (620) coupled to a processor (630), and a light control element (100) as claimed in claim 1 placed in front of the light sensor (620), the electronic device further comprising driver circuitry (640) coupled to the plurality of electrodes.
